(19) United States
(12) Patent Application Publication
(10) Pub. No.: US 2009/0126099 A1
(43) Pub. Date: May 21, 2009

(54) Bearingless pin hydrotherapy jet

(75) Inventor: Michael D. Holtsnider, Moorpark, CA (US)

Correspondence Address: KOPPEL, PATRICK, HEYBL & DAWSON, 2815 Townsgate Road, SUITE 215, Westlake Village, CA, 91361-5827, US

(73) Assignee: B & S PLASTICS, INC. dba WATERWAY PLASTICS

(21) Appl. No.: 12/313,210

(22) Filed: Nov. 17, 2008

Related U.S. Application Data
(60) Provisional application No. 61/003,421, filed on Nov. 16, 2007.

(51) Int. Cl. A61H 33/00; E03C 1/08

(52) U.S. Cl. 4/541.6; 239/428.5

(57) ABSTRACT

A hydrotherapy jet is disclosed which has a jet body with a water inlet to allow water to flow into it. An eyeball with one or more outlets is mounted to the body to allow water to flow out of the body through the outlets. The flow of water through the outlets causes the eyeball to rotate. A retaining pin is mounted within the jet body to hold the eyeball to the body, with the eyeball rotating around said pin. A system for providing a hydrotherapy jet to a reservoir of water is also disclosed and includes a reservoir shell capable of holding water with a plurality of hydrotherapy jets according to the invention that are mounted around the reservoir shell. A water pump system circulates water from the reservoir to said jets.

This application claims the benefit of provisional application Ser. No. 61/003,421 to Michael D. Holtsnider, which was filed on Nov. 16, 2007.

### BACKGROUND OF THE INVENTION

1. Field of the Invention

This invention relates to hydrotherapy jets and more particularly to hydrotherapy jets with rotating outlets.

2. Description of the Related Art

Various hydrotherapy jets have been developed for use in spas, hot tubs, pools and bath tubs (collectively “spas”) that discharge a stream of water, which can be aerated through a variety of discharge nozzles. The designs provide different flow characteristics that result in different massage affects being experienced by the body of the spa user. Such jets have been found to produce a pleasing massaging effect for many users, and have become quite popular. In the design of single or multi-user spas, it is common to use a variety of different jet nozzles to provide a variety of different massaging effects.

Early jets simply discharged a steam of warm water along the longitudinal axis of the jet body, with later jets providing aeration of the water stream. Since then, numerous jets have been developed in which the direction of the stream can be adjusted. For example, U.S. Pat. No. 5,269,029 to Spears et al. (assigned to the same assignee as the present invention) discloses a jet that provides an off axis stream of water and has an axial push/pull mechanism used to control the flow of water. The mechanism can also be rotated to rotate the stream of water around the jet axis, providing directional control over the stream.

Jets have also been developed having a rotating outlet or eyeball that automatically rotates in response to the water flowing through the outlet. See Waterway Plastics Inc., “1999 Product Catalog,” Page 4, including Part Nos. 210-6120 and 210-6510. The jet produces a water stream that passes through the outlet, and the outlet can be adjusted off the jet's longitudinal axis to provide a turning moment in the eyeball in response to the jet flow.

U.S. Pat. No. 6,178,570 to Denst et al. (assigned to the same assignee as the present invention) discloses a jet having a rotating eyeball with one or more discharge outlets that can be adjusted to vary the direction of the outlet flow stream as well as the direction and speed of the eyeball's rotation. A high-pressure water stream flows through the outlets and, depending upon the orientation of the outlets, the eyeball can rotate clockwise or counterclockwise at different speeds.

U.S. Pat. No. 5,920,925, to Dongo (assigned to the same assignee as the present invention) discloses a jet having a rotating eyeball and a diverter cap formed with a number of bore holes positioned at a common radius from the center of the cap. The jet produces a high pressure water jet that flows through the eyeball, causing it to rotate at a high speed and discharge the water stream in a circular pattern that impinges on the bore holes. Together, the rotational speed and the bore hole design produce the sensation of a number of simultaneously pulsating water jets that are directed into the spa.

The aforementioned rotating jets rely on internal bearings to allow the outlet or eyeball to rotate. This approach is effective in allowing free rotation, but the bearings are relatively expensive and can add complexity in design and manufacturing of the jets. Also, calcium can build up on the bearings from water and over time the build-up can prevent the free rotation of the outlet.

U.S. Pat. No. 5,226,601 to Hinojosa Jr. et al. (assigned to the same assignee as the present invention) describes a jet with an alternative mechanism for allowing an outlet or eyeball to rotate. A bridge stretches across the front face of the jet and includes a rearward-directed cup mounted at the center of the bridge along the jet's longitudinal axis. The cup holds a bushing, which in turn holds a pin. The pin extends into a corresponding opening in the front end of the eyeball to hold it in place. The eyeball rotates in response to a steam of water passing through it by having its outlet angled to the jet's longitudinal axis.

In this arrangement, the bridge can add to the cost and complexity of the jet's design and manufacture. Also, the jet usually includes one or more internal nozzles that form the stream of water flowing through the jet into a venturi. This allows air to be entrained into the stream of water to provide an aerated stream. However, the vacuum effect of the venturi tends to pull the outlet toward the back of the jet. As a result, the pin/bushing combination must hold the eyeball within the cup against the pull of the venturi vacuum, which makes the bridge type jet difficult to design and manufacture. Also, the bridge interferes with the stream of the water from the rotating outlet as it passes under the arms of the bridge. This results in multiple interruptions in the flow of water, which may be undesirable in some circumstances.

U.S. Pat. No. 6,291,621 to Mathis describes a spa jet assembly having a pin shaft that extends along the entire length of the jet. It is held in a circular opening in the rear-most surface of the jet by a pop rivet. The pin passes through a jet head with the jet head being held by a pop rivet, so that there are opposing pop rivets on the pin.

One disadvantage of this jet arrangement is that if the rear of the jet is used as the water inlet, a significant portion of the inlet is blocked by a rear axial surface that supports the circular opening. This restricts the amount of water that can pass into the jet and creates turbulence in the water that does pass into the jet. If the rear of the jet is not used as a water inlet, such as in jets with side water inlets, the rivet and pin pass through the rear of the jet, which creates an opening through which water can leak.

### SUMMARY OF THE INVENTION

The present invention seeks to provide a hydrotherapy jet with an improved mechanism to allow the jet's outlet to rotate, the mechanism being less complex, less expensive and more durable. One embodiment of a hydrotherapy jet system according to the present invention provides a jet body, a water inlet to allow water to flow into the jet body, and an eyeball mounted within the jet body. The eyeball comprises an outlet to allow water to flow out of the jet body, with the flow of water causing the eyeball and outlet to rotate. Further, a retaining pin is provided having mounting points within the jet body and holding the eyeball with respect to the jet body such that the eyeball and outlet rotate around the pin.

Pursuant to another embodiment, a hydrotherapy jet system

In accordance with yet another embodiment, a system for providing a hydrotherapy jet to a reservoir of water is provided.

These and other further features and advantages of the invention will be apparent to those skilled in the art from the following detailed description, taken together with the accompanying drawings, in which:

### BRIEF DESCRIPTION OF THE DRAWINGS

FIG. 1 is a perspective view of one embodiment of a hydrotherapy jet according to the present invention;

FIG. 2 is an alternative perspective view of the jet shown in FIG. 1;

FIG. 3 is an exploded view of the jet in FIG. 1;

FIG. 4 is a perspective view of the decorative jet cover used in the jet shown in FIGS. 1-3;

FIG. 5 is a bottom view of the decorative jet cover used in the jet shown in FIGS. 1-3;

FIG. 6 is a top perspective view of the eyeball used in the jet shown in FIGS. 1-3;

FIG. 7 is a bottom view of the eyeball used in the jet shown in FIGS. 1-3;

FIG. 8 is a perspective view of another embodiment of a hydrotherapy jet according to the present invention;

FIG. 9 is a top perspective view of the eyeball used in the jet shown in FIG. 8; and

FIG. 10 is a perspective view of a spa/tub system using a jet according to the present invention.

### DETAILED DESCRIPTION OF THE INVENTION

The following description presents preferred embodiments of the invention representing exemplary modes contemplated for practicing the invention. This description is not to be taken in a limiting sense but is made merely for the purpose of describing the general principles of the invention, the scope of which is better understood by the appended claims.

The present invention generally provides a hydrotherapy jet with an improved mechanism to allow the jet's outlet to rotate, the mechanism being relatively incomplex, economical and durable. The invention also seeks to provide a hydrotherapy jet having outlets that rotate without relying on bearings while at the same time avoiding structures that interfere with the flow of water through the inlet and from the outlets.

These goals may be generally realized with a retaining pin that is mounted within the jet body to hold the eyeball to the body, with the eyeball rotating around the pin. A plurality of such hydrotherapy jets can be mounted around a reservoir shell such as a spa or tub, with a water pump system circulating water from the reservoir to each of the jets.

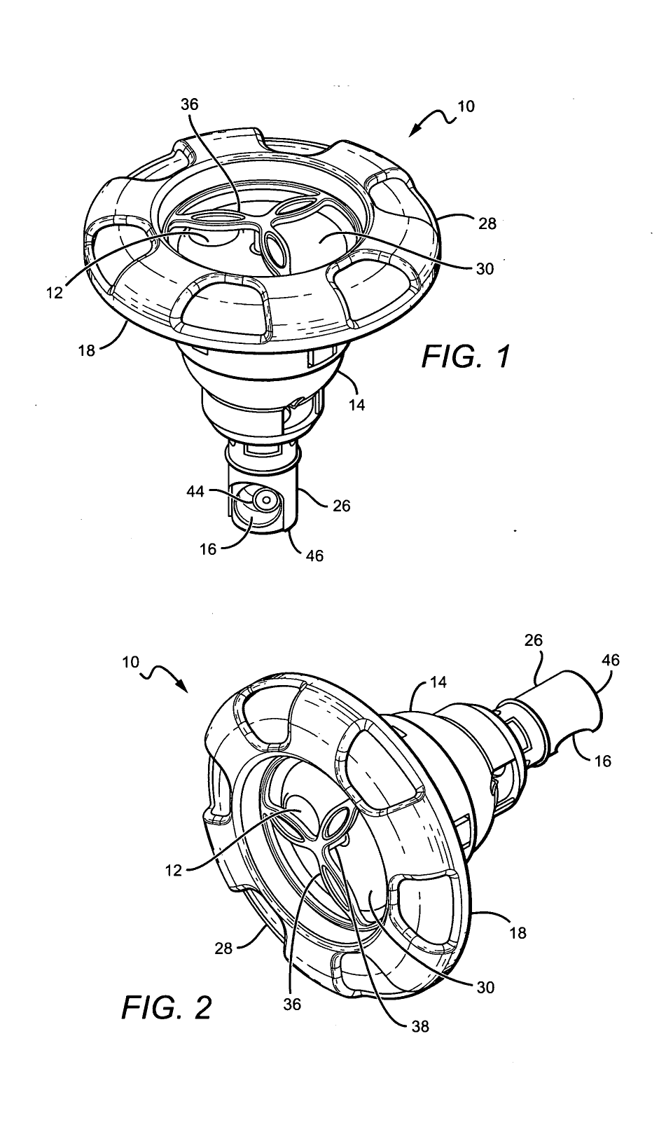

FIGS. 1-3 show one embodiment of a hydrotherapy jet 10 constructed in accordance with the present invention, having a rotating outlet 12. The jet 10 and its components are preferably formed from a water impervious plastic such as ABS, PVC or CPVC, but can be formed from a number of different materials. It is particularly adapted to be positioned below the water level on the spa or tub wall, with the majority of the jet positioned behind the spa's water contacting wall.

The jet 10 includes a jet body 14 having a water inlet opening 16. The body 14 can also have an air inlet tube to allow air into the body 14 in applications where aerated water is desired. The jet body 14 has an external flange 18 that is positioned on the spa's water contacting wall. The outside surface (not shown) of the body 14, adjacent to the flange 18, has a threaded section for mating with the threads of a wall fitting. A circular gasket, o-ring, or other devices or compounds that provide a watertight seal (not shown) can be used on the wall fitting and/or flange 18 to provide a seal with the wall. The fitting is rotated until the flange 18 tightens against the spa wall. The jet 10 is held securely in place with the spa wall sandwiched between the flange 18 and the fitting.

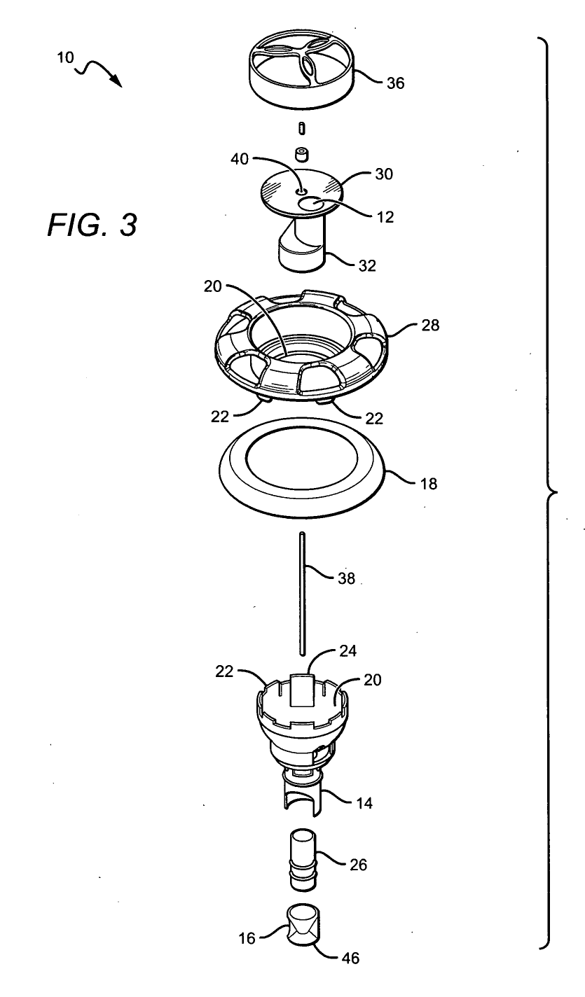

The jet body 14 houses an internal escutcheon 20 that is mounted within the body 14 by escutcheon tabs 22 (best shown in FIG. 3). The front edge of each tab 22 projects slightly outward and, as the escutcheon is inserted into the body 12, the tabs 22 are compressed in toward the jet's longitudinal axis. When the tabs 22 pass a lip 24 on the jet body's internal surface, they expand to their projected position so that the escutcheon 20 is held in the body 14 by the front edges of the tabs 22 butting against the lip 24. In the jet 10 the escutcheon 20 is one unit, but for ease of molding or manufacture it could also be made of multiple pieces that are bonded, fitted or mounted together.

Cylindrical nozzle 26 has water inlet opening 16 to allow water from and inlet pipe into the nozzle 26. When the jet is installed in a spa, a spa occupant can control the amount of water that passes into the nozzle 26 by grasping the escutcheon flange 28 and rotating the escutcheon 20 within the body, which changes the alignment of the opening 16 with an inlet. When the opening 16 is fully aligned with the inlet, the maximum amount of water enters the nozzle 26, which causes the outlet 12 to rotate at its maximum speed. Moving the opening 16 out of alignment with the inlet reduces the amount of water entering the nozzle, which reduces the rotational speed of the outlet 12. When the opening 16 is moved completely out of alignment with the inlet, no water enters the nozzle 26 and the outlet 12 does not rotate.

The interior surface of the nozzle 26 may have a Venturi section (not shown) that tapers slightly to accelerate the water flowing through the nozzle, creating a Venturi jet. Forward of the Venturi section can be axial air passageways. Air enters the jet body 12 through an air inlet and the air can then flow to the forward end of the Venturi section through axial air passageways. At that location, air is entrained into the water jet due to the Venturi action, producing a jet with a desirable water/air mixture.

The outlet 12 is formed in an eyeball 30 which is housed within the escutcheon 20. The eyeball 30 may comprise a number of varying shapes, with one possible acceptable shape best shown in FIG. 7. Additionally, although only one outlet 12 is shown, it is understood that more than one outlet may also be included in eyeball 30.

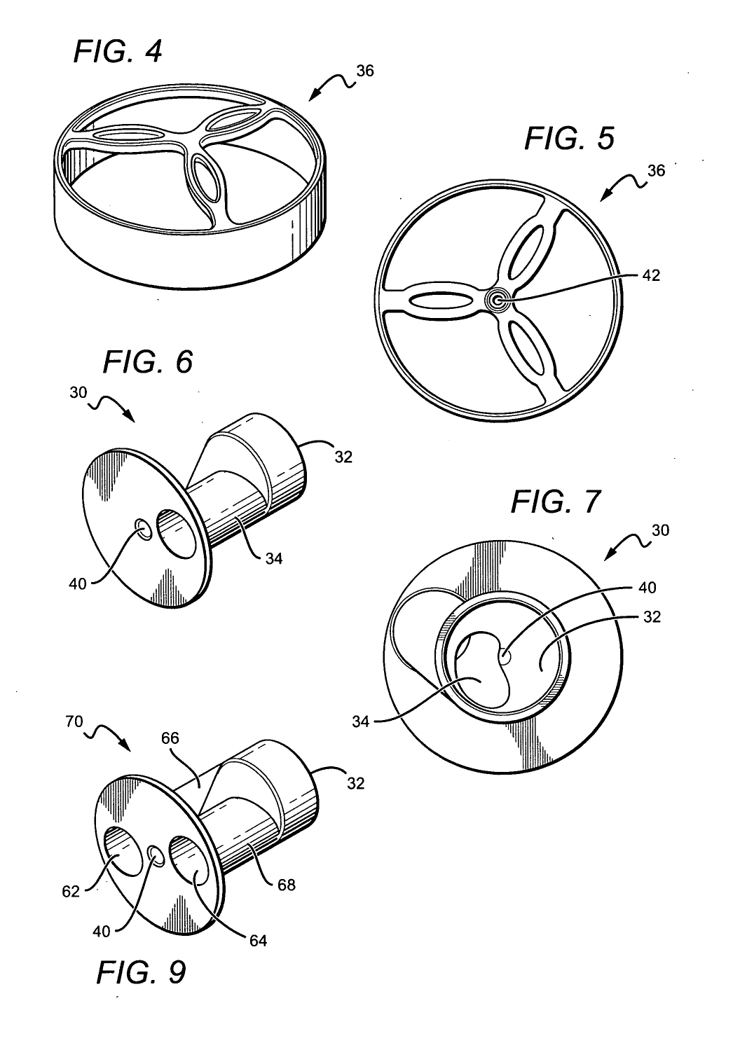

The stream of water from nozzle 26 passes into the bottom inlet 32 (shown in FIGS. 6 and 7) of eyeball 30, through the angled passageway 34 through eyeball 30, and out the outlet 12 and into the spa. The passageway 34 is angled and outlet 12 is angled off the longitudinal axis of the jet 10, which provides a turning movement in the eyeball 30 in response to the jet flow, causing the eyeball 30 to rotate around a central retaining pin 38. The passageway 34 may be angled in a variety of configurations, with one acceptable configuration best shown in FIG. 7. The eyeball 30 may be covered by decorative jet cover 36 (shown in FIGS. 1-5), which is partially included for aesthetics to hide the eyeball 30 from the spa occupants. While FIGS. 1-5 depict one possible embodiment of a decorate jet cover 36, it is understood that any suitable design for a jet cover may also be used within the scope of the present invention.

The eyeball 30 is held within the escutcheon 20 by retaining pin 38, which can be made of many different materials, but is preferably made of a metal. The pin's axial section is arranged along the jet's longitudinal axis. The eyeball 30 is mounted on the pin 38 by passing the axial section through central hole 40 in the eyeball 30. A bushing 42 is included in the center of the inwardly facing decorative jet cover 36, which accepts one end of retaining pin 38. The bushing 42 prevents the top of the eyeball 30 from striking the inwardly facing side of decorative jet cover 36 when it is spinning. A second bushing 44 (best shown in FIG. 1) is included in the center of the base 46 of jet body 14, which accepts the other end of retaining pin 38.

In operation, water enters the body 14 through the inlet 16 and passes into the nozzle 26, with the amount of water entering depending on the alignment of the nozzle opening and the inlet 16. The nozzle's tapered section forms a Venturi and air may be entrained into the nozzle's water stream to form an aerated jet. This jet passes into the eyeball 30 and passes through the outlet 12, which causes the eyeball to rotate about the pin 38. The bushings 42, 44 or other retaining device prevents the outlet from being pushed off the pin by the force of the water flow.

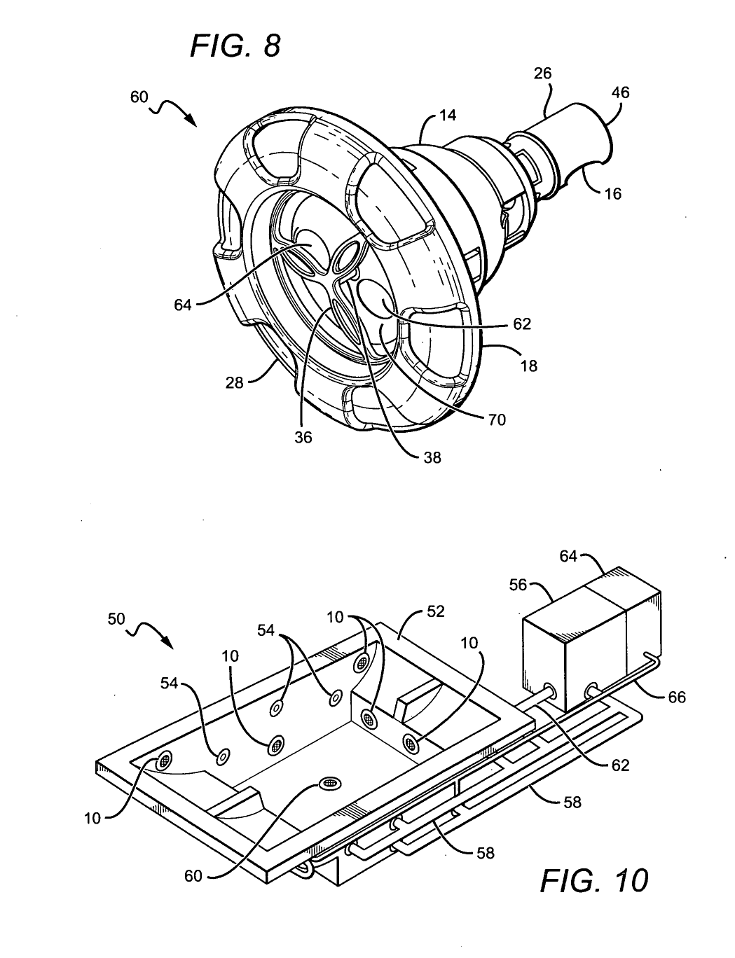

FIGS. 8 and 9 show another jet 60 according to the present invention having most of the same components as the jet 10. The primary difference between the two is that jet 60 has an eyeball 70 with two outlets 62, 64 and two angled passageways 66, 68. The jet 60 operates much the same way as jet 10 and has the same pin 38 to retain the eyeball 70 within the body 14. It also has water inlet 16, flange 18, nozzle 26, escutcheon flange 28, bottom inlet 32, jet cover 36, central hole 40, base 46 and all other relevant components of jet 10. Water enters the jet 60 through the inlet 16 and passes through the nozzle. The water stream, which may be aerated, enters the eyeball 70 and water is diverted into the two outlets 62 and 64 via angled passageways 66, 68. The outlets are angled off the jet's longitudinal axis causing the outlet assembly to rotate. The pin's central hole 40 extends between the two outlets 62 and 64.

As shown in the spa/tub system 50 of FIG. 10, multiple jets can be installed in a spa or tub shell 52. Some or all of the jets can be one of the jets described above, with the jets in this embodiment being jet 10. The remaining jets can be any other desired type, such as a variety of prior single nozzle jets 54. Both types of jets are connected to a water pump 56, used to circulate the water throughout the spa system, by a series of water conduits 58. Water from shell 52 is provided to pump 56 through the drain 60, which is connected through return water conduit 62 to pump 56. Water from pump 56 is provided back to shell 52 by conduits 58, where it flows into jets 10 and 54, as the case may be, and in turn into shell 52, completing the loop. Additionally, an air system 64 can be included that provides air to individual jets 10 and 54 through an air conduit 66, to aerate the water flowing through the jet. The air system 64 can be pump driven to increase the pressure of the air entering the jet 10, or can be vacuum based with the Venturis located within the jets 10 drawing air into the jets 10 and water flow stream.

Although the present invention has been described in considerable detail with reference to certain preferred configurations, other versions are possible. The invention can be used in many different types of hydrotherapy jets. Different outlets and eyeballs can be used, and different pin arrangements can be used to hold the eyeball in the body. Other jets can also have a water outlet alone, without air. Therefore, the spirit and scope of the appended claims should not be limited to the versions described above.

We claim:

1. A hydrotherapy jet, comprising:
a jet body;
a water inlet to allow water to flow into said body;
an eyeball mounted within said body, said eyeball comprising an outlet to allow water to flow out of said body, the flow of water causing said eyeball and outlet to rotate; and
a retaining pin having mounting points within said body and holding said eyeball with respect to said body, said eyeball and outlet rotating around said pin.

2. The jet of claim 1, further comprising a nozzle within said body, said nozzle forming the water flowing into said body into a Venturi.

3. The jet of claim 2, further comprising an air inlet into said body, said air inlet allowing air into said body to be entrained into said water.

4. The jet of claim 1, further comprising an escutcheon within said body which houses said outlet.

5. The jet of claim 4, wherein said escutcheon is rotatable to control the amount of water flowing through said body.

6. The jet of claim 1, wherein said retaining pin is elongate and extends along the longitudinal axis of said jet through a central hole extending in said eyeball.

7. The jet of claim 1, wherein said eyeball may be covered by a decorate jet cover.

8. The jet of claim 7, wherein said mounting points for the retaining pin comprise bushings on both of said pin's respective ends.

9. The jet of claim 8, wherein one of said bushings is located on the inwardly facing side of said jet cover.

10. The jet of claim 8, wherein the other of said bushings is located on the center of the base of said jet body.

11. The jet of claim 1, wherein said outlet is angled to provide a turning moment in response to water flowing through it.

12. The jet of claim 1, wherein said body and said eyeball are preferably formed from a water impervious plastic.

13. The jet of claim 1, wherein said retaining pin is preferably formed from a metal.

14. A hydrotherapy jet, comprising:
a jet body;
a water inlet to allow water to flow into said body;
an eyeball mounted within said body, said eyeball having one or more outlets to allow water to flow out of said body, the flow of water through said outlets causing said eyeball and said outlets to rotate; and
a retaining pin having mounting points within said body and holding said eyeball with respect to said body, said eyeball and outlets rotating around said pin.

15. The jet of claim 14, wherein said retaining pin is elongate and extends along the longitudinal axis of said jet through a central hole between said outlets extending in said eyeball.

16. The jet of claim 14, wherein said mounting points for the retaining pin comprise bushings on both of said pin's respective ends.

17. The jet of claim 16, wherein one of said bushings is located on the inwardly facing side of a decorate jet cover.

18. The jet of claim 16, wherein the other of said bushings is located on the center of the base of said jet body.

19. The jet of claim 14, wherein said one or more outlets are angled to provide a turning moment in response to a water flow.

20. A hydrotherapy jet system, comprising:
a reservoir shell capable of holding water;
a plurality of hydrotherapy jets mounted around the reservoir shell;
a water pump system that circulates water from said reservoir to said jets; and
selected one of said jets having an eyeball comprising one or more outlets providing a stream of water when said water pump is operated, said stream of water running through said outlets and causing said eyeball and outlets to rotate, and a retaining pin to hold said eyeball within said jet, said eyeball and outlets rotating around said pin.

21. The system of claim 20, further comprising an air system that provides an air intake to each of said jets.

22. The system of claim 20, wherein each of said jets, comprise:
a jet body; and
a water inlet to allow water to flow into said body.

23. The system of claim 22, further comprising a nozzle within said body and an air inlet to said body, said nozzle forming the water flowing into said body into a Venturi, and said air inlet allowing water into said body to be entrained into said water.

24. The system of claim 22, further comprising an escutcheon within said body which houses said eyeball.

25. The system of claim 24, wherein said escutcheon is rotatable to control the amount of water flowing through said body.

26. The system of claim 20, wherein said retaining pin is elongate and extends along the longitudinal axis of said jet through a central hole between said outlets extending in said eyeball.

27. The system of claim 20, wherein said retaining pin is held in place by bushings on both of said pin's respective ends.

28. The system of claim 27, wherein one of said bushings is located on the inwardly facing side of a decorate jet cover.

29. The system of claim 27, wherein the other of said bushings is located on the center of the base of said jet body.

30. The system of claim 20, wherein said one or more outlets are angled to provide a turning moment in response to a water flow.
